(19) United States
(12) Patent Application Publication
(10) Pub. No.: US 2024/0057805 A1
(43) Pub. Date: Feb. 22, 2024

(54) BREW CHAMBER FOR FRENCH PRESS COFFEE MACHINE

(71) Applicant: J DEAN LLC, Lima, OH (US)

(72) Inventor: Jared Hollar, Lima, OH (US)

(21) Appl. No.: 18/453,727

(22) Filed: Aug. 22, 2023

Related U.S. Application Data
(60) Provisional application No. 63/399,799, filed on Aug. 22, 2022.

(51) Int. Cl. A47J 31/20; A47J 31/46; A23F 5/26; A47J 31/60

(52) U.S. Cl. CPC A47J 31/20; A47J 31/468; A23F 5/26; A47J 31/60

(57) ABSTRACT

A French press coffee machine for brewing coffee from coffee grounds is provided. The coffee machine can include a brew chamber, a piston, and a motor. The brew chamber can be selectively moveable between a first position, a second position, and a third position. The brew chamber in the first position can be configured to receive coffee grounds. The brew chamber in the second position can be configured to brew coffee. The brew chamber in the third position configured to compress the coffee grounds. The piston can be selectively moveable between a first point and a second point to separate the coffee grounds from the brewed coffee. The motor can be disposed adjacent to the brew chamber and can be configured to selectively move the brew chamber and the piston. The present disclosure also provides a method for brewing coffee from coffee grounds.

### CROSS-REFERENCE TO RELATED APPLICATIONS

This application claims the benefit of U.S. Provisional Application No. 63/399,799, filed on Aug. 22, 2022. The entire disclosure of the above application is incorporated herein by reference.

### FIELD

The present technology relates to an automated French press machine and, more specifically, a brew chamber for an automated French press machine.

### INTRODUCTION

This section provides background information related to the present disclosure which is not necessarily prior art.

Approximately three billion cups of coffee are brewed worldwide every day. Many coffee drinkers take their brewing methods very seriously and prefer one method to another. One of the most popular brewing methods is the French press.

The French press method can be less expensive and yet can provide a more full-bodied flavor to the coffee as opposed to an espresso machine. The French press method allows the brewer to accurately control the process to obtain uniform extraction of the essential oils and other components of the ground coffee into the hot water with which it is mixed. However, the French press requires the user to manually make the coffee in a series of steps. When using a French press, fresh dry coffee grounds are placed in a container and then all the hot water that will be used to make the desired quantity of coffee is quickly added and mixed with the coffee grounds. The mixture is allowed to seep for a preselected, relatively short period of time statically or while stirring. The remaining solids are then quickly removed from the liquid to obtain uniform extraction associated with a high-quality brew. For example, at the end of the mixing or seeping time period, a piston can be quickly manually plunged into the container to rapidly separate the liquid coffee beverage from the solid materials of the remaining coffee grounds to quickly stop further extraction. In this way, it is possible to avoid both under-extraction and over-extraction, both of which are associated with less than optimum quality. Once the coffee is brewed, the grounds must be cleaned out of the container.

Although the French press method results in a full-bodied cup of coffee, the process is labor intensive and requires not only several steps but a lot of time. Further, if the brewer wishes to make several cups at a time, the French press must be cleaned between each brew. This can result in the brewer having to clear away hot, wet, messy coffee grounds.

Accordingly, there is a continuing need for a French press coffee machine that militates against channeling of coffee grounds.

### SUMMARY

In concordance with the instant disclosure, a French press coffee machine that militates against channeling of coffee grounds, has surprisingly been discovered.

The present disclosure includes a French press coffee machine. The French press coffee machine can include a brew chamber, a piston, and a motor. The brew chamber can be selectively moveable between a first position, a second position, and a third position. The brew chamber in the first position can be configured to receive coffee grounds and the brew chamber in the second position can be configured to brew coffee. The brew chamber in the third position configured to compress the coffee grounds. The piston can be disposed within the brew chamber and can be selectively moveable between a first point and a second point to separate the coffee grounds from the brewed coffee. The motor can be disposed adjacent to the brew chamber and configured to selectively move the brew chamber and the piston.

The present disclosure further provides a method for brewing coffee from coffee grounds. A French press coffee machine as described hereinabove can be provided along with coffee grounds. The brew chamber can be placed into the first position for receiving coffee grounds. The coffee grounds can be placed in the brew chamber. The brew chamber can be filled with water. The brew chamber can be placed into the second position and the motor can pulse the brew chamber to saturate the coffee grounds with the water. The coffee grounds can be brewed for a predetermined amount of time. After the predetermined amount of time, the piston can move from the first point to the second point whereby the coffee grounds are separated from the brewed coffee. The brewed coffee can be drained from the brew chamber. The coffee grounds atop the piston can be swept away by the arm disposed adjacent to the brew chamber as the brew chamber moves from the second position to the first position. The process can be repeated such that a desired amount of coffee is brewed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a French press coffee machine;

FIG. 2 is a right-side elevational and cutaway view taken at the A-A section line of FIG. 1 of the French press coffee machine;

FIG. 3 is a right-side internal view taken at section line A-A of FIG. 1 and depicting callout C-C of FIG. 2 of a brewing system of the French press coffee machine;

FIG. 4 is a right-side internal and partial cross-sectional view taken at section line B-B of FIG. 1 of a brew chamber in a first position and a piston at a first point;

FIG. 5 is a right-side internal and partial cross-sectional view taken at section line B-B of FIG. 1 of the brew chamber moving into a second position;

FIG. 6 is a right-side elevational, cross-sectional view taken at section line B-B of FIG. 1 of the brew chamber in the second position and the piston at the first point;

FIG. 7 is a right-side elevational, cross-sectional view taken at section line B-B of FIG. 1 of the piston moving from the first point to a second point;

FIG. 8 is a right-side elevational, cross-sectional view taken at section line B-B of FIG. 1 of the piston at the second point;

FIG. 9 is a right-side elevational, cross-sectional view taken at section line B-B of FIG. 1 of the brew chamber moving from the second position to a third position;

FIG. 10 is a right-side elevational, cross-sectional view taken at section line B-B of FIG. 1 of the brew chamber moving from the third position to the first position and an arm sweeping the grounds from the piston;

FIG. 11 is a right-side elevational, cross-sectional view taken at section line B-B of FIG. 1 of the piston moving from the second point to the first point;

FIG. 12 is a top perspective view of the brew chamber moving from the second position to the first position and the piston at the second point;

FIG. 13 is a schematic of the French press coffee machine where the arrows with dotted fill indicate coffee bean or grounds movement and the arrows with diagonal line fill indicate fluid movement; and

FIGS. 14A and 14B are flow diagrams for a method for brewing coffee from coffee grounds.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

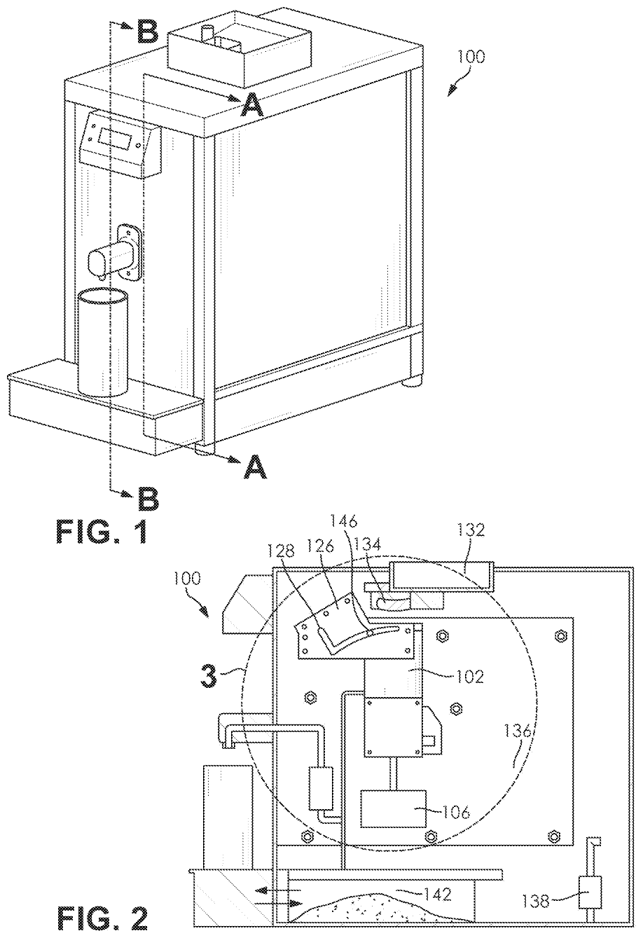

The present technology relates to a French press coffee machine 100 for brewing coffee 101 from coffee grounds 103, shown generally in FIGS. 1-13. Advantageously, the coffee machine 100 can improve the distribution of water among the coffee grounds 103 to minimize channeling, where channeling occurs when water finds the path of least resistance through the coffee bed resulting in uneven extraction and dry particle resistance. Minimizing channeling and uneven extraction can produce a superior brewed coffee 101 with consistency in taste and strength.

With reference to FIGS. 4-10, the coffee machine 100 can include a brew chamber 102, a piston 104, and a motor 106. The brew chamber 102 can be selectively moveable, or tilted, between a first position 108, a second position 110, and a third position 111. The brew chamber 102 in the first position 108 can be configured to receive coffee grounds 103. The brew chamber 102 in the second position 110 can be configured to brew coffee. The brew chamber 102 in the third position 111 can be configured to compress the coffee grounds.

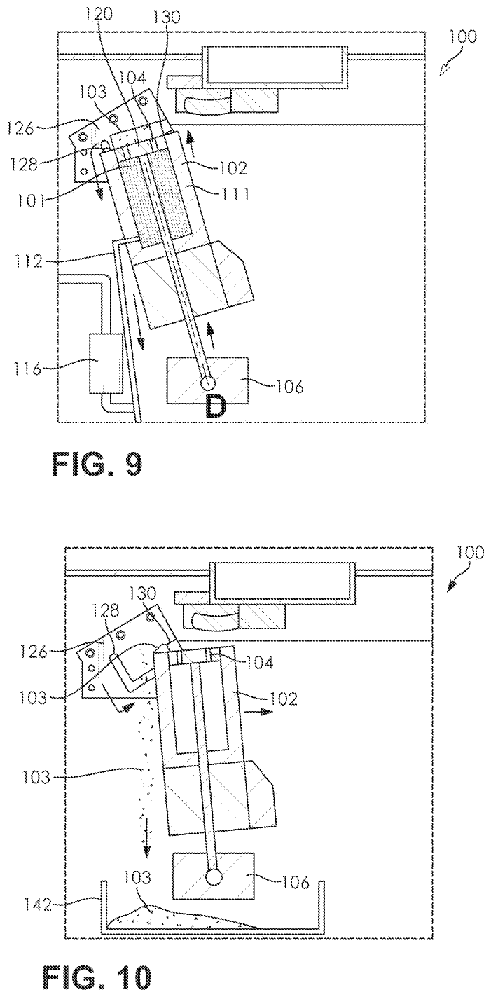

In the first position 108, the brew chamber 102 can be substantially vertical along an Axis C, as shown in FIG. 4. In the second position 110, the brew chamber 102 can be disposed along Axis D, shown in FIG. 6. As depicted in FIGS. 4-6, the brew chamber 102 can tilt between Axis C and Axis D at an angle (a) disposed between Axis C and Axis D. As a non-limiting example, the angle at which the brew chamber 102 can tilt between the first position 108 and the second position 110, and therefore between Axis C and Axis D, can be between about 10° and about 50°. More particularly, the angle can be between about 20° and about 40°. Most specifically, the angle can be about 30°. One of ordinary skill can select other suitable angles for the brew chamber 102 to tilt between the first position 108 and the second position 110 within the scope of the present disclosure. Advantageously, brewing the coffee 101 at an angle can improve saturation of the coffee grounds 103 when used in combination with a pulsating motion applied by the motor 106 to the brew chamber 102. Additionally, the angled nature of the brew chamber 102 in the second position 110 can allow for the brewed coffee 101 to fully dispense from the brew chamber 102 due to the funnel like nature of the brew chamber 102 in the second position. To this point, where the brew chamber 102 is in the second position 110, tilted at an angle, the point at which the brew chamber 102 tilts creates a funnel shape within the brew chamber 102. Further, as depicted in FIG. 9, the brew chamber 102 can move from the second position 110 to the third position 111 by moving upwardly along Axis D.

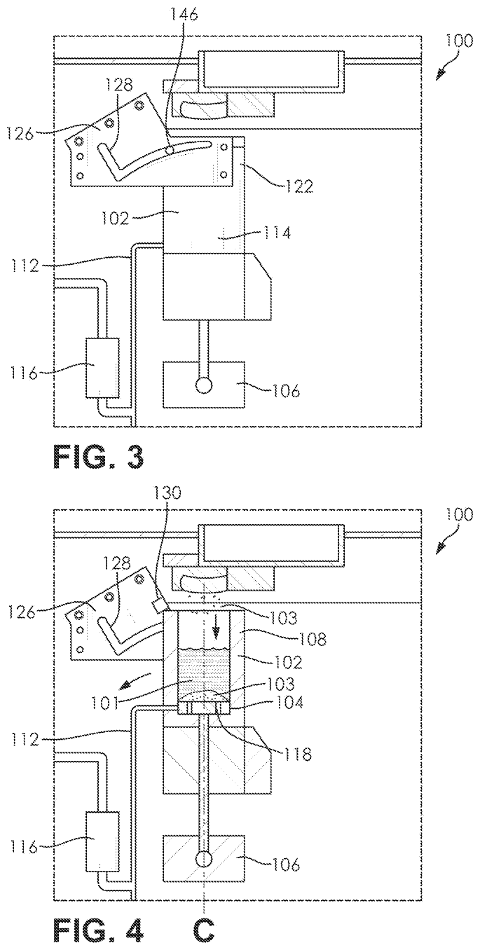

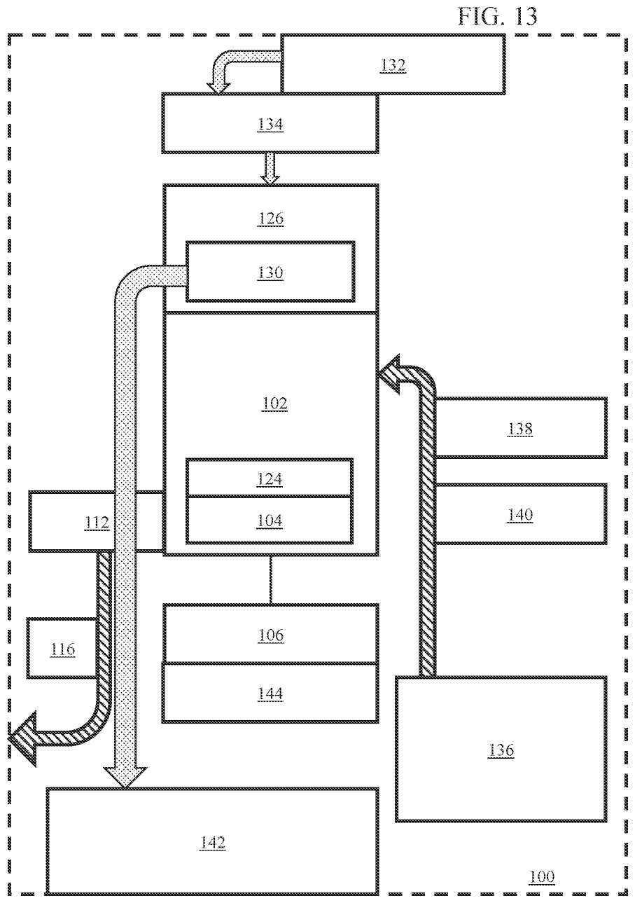

With reference to FIGS. 3 and 13, the brew chamber 102 can include an exit port 112. The exit port 112 can be disposed in a bottom portion 114 of the brew chamber 102 to allow for liquid to exit the brew chamber 102 upon completion of a predetermined brewing time. The exit port 112 can be actuated by the coffee machine 100 after the predetermined brewing time has elapsed. The exit port 112 can further include tubing, shown in FIG. 9, that allows the coffee to flow from the brew chamber 102 to a dispensing area of the coffee machine 100. As described herein and with reference to FIG. 13, the arrows shown with dotted fill indicate coffee bean or grounds movement and the arrows shown with diagonal line fill indicate fluid movement. Further, the coffee machine 100 can include a pump 116 connected to the exit port 112. The pump 116 can be configured to move the brewed coffee 101 from the brew chamber 102 to be dispensed from the coffee machine 100. The pump 116 can pump the brewed coffee 101 from the brew chamber 102 at a rate of about 18.8 grams per second. A skilled art can select a suitable rate for the pump 116 to move the coffee from the brew chamber 102 within the scope of the present disclosure.

With reference to FIGS. 4-11, the piston 104 can be disposed within the brew chamber 102. The piston 104 can be selectively moveable between a first point 118 and a second point 120 within the brew chamber 102. In operation, the piston 104 can move between the first point 118 proximate the bottom portion 114 of the brew chamber 102 and the second point 120 proximate a top portion 122 of the brew chamber 102. The piston 104 moves from the first point 118 to the second point 120 to separate the coffee grounds 103 from the brewed coffee 101 after the predetermined brewing time has elapsed. It should be appreciated that the piston 104 can include a filter portion 124 that allows the brewed coffee 101 to pass through the piston 104. As such, although the brewed coffee 101 can pass through piston via the filter portion 124, the coffee grounds 103 can be collected atop the piston 104 as it moves from the first point 118 to the second point 120. The piston 104 can remain at the second point 120 as the brew chamber 102 moves from the second position 110 to the third position 111. Where the brew chamber 102 is in the third position 111, the coffee grounds can be compressed upon a top portion 127 of the guide member 126 by the brew chamber 102 moving from the second position 110 to the third position 111 along Axis D in the same direction as the piston 104 from the first point 118 to the second point 120.

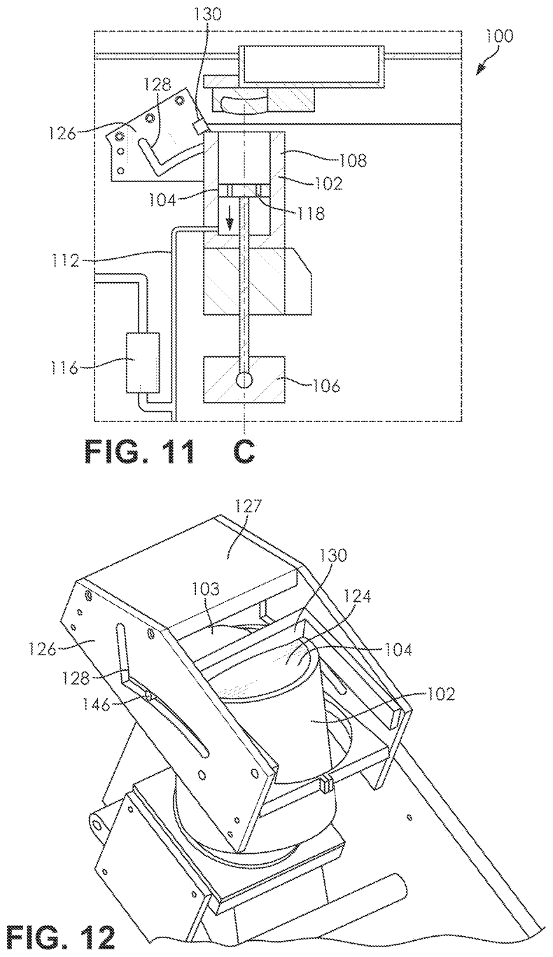

As shown in FIG. 12, the brew chamber 102, can be cylindrical in shape. An interior circumference of the brew chamber 102 can be substantially the same as or equal to an exterior circumference of the piston 104. In this way, the cylindrical nature of the brew chamber 102 can facilitate operation with the piston 104 by militating against coffee grounds 103 from contaminating the brewed coffee 101 post the separation process by falling down around the piston as it moves from the first point 118 to the second point 120. A skilled artisan can select a suitable shape for the brew chamber 102 and the piston 104 within the scope of the present disclosure. Further, a skilled artisan can select a suitable circumference for the brew chamber 102 and piston 104 within the scope of the present disclosure.

With reference to FIG. 4, the motor 106 can be disposed adjacent to the brew chamber 102. The motor 106 can also be configured to selectively move the brew chamber 102 between the first position 108 and the second position 110 and the piston 104 between the first point 118 and the second point 120. The motor 106 can be responsive to commands given by a controller 144 concerning when to move the brew chamber 102 between the first position 108 and the second position 110 as well as when to move the piston 104 between the first point 118 and the second point 120 based on previously programmed attributes such as an auto start time, a selectable brewing time, a selectable brew volume, and a selectable coffee strength. The motor 106 can be any type of motor, such as a stepper motor, suitable to move the brew chamber 102 and drive the piston 104. The coffee machine 100 can include multiple motors 106 to control separately the brew chamber 102 and the piston 104. A skilled artisan can select a suitable motor 106 within the scope of the present disclosure.

In operation, the motor 106 can selectively pulsate the brew chamber 102 to saturate the coffee grounds 103 with water. Pulsating by the motor 106 can be done in conjunction with moving the brew chamber 102 from the first position 108 to the second position 110 or, alternatively, can occur while the brew chamber 102 is in the second position alone. Pulsating the motor 106 while in the second position 110 and therefore, at an angled position relative to the first position 108, can improve saturation of the coffee grounds 103. In this way, it should be appreciated that the angled position of the brew chamber 102 in the second position 110 can improve the distribution of water among the coffee grounds 103 to minimize channeling, where water finds the path of least resistance through the bed of coffee grounds 103 resulting in uneven extraction and dry particle resistance. Improved water saturation of the coffee grounds and minimized channeling therefore produces a superior brewed coffee 101.

As shown in FIGS. 2-12, the coffee machine 100 can further include a guide member 126. The brew chamber 102 can be slidably disposed with respect to the guide member 126. Further, the brew chamber 102 can be moveable, or tilted, between the first position 108 and the second position 110 along the guide member 126. The guide member 126 can include a channel 128 that guides the brew chamber 102 from the first position 108 to the second position 110 and guides return of the brew chamber 102 from second position 110 to the first position 108. As such, the channel 128 can act as a pathway for the brew chamber 102. As shown in FIG. 2, the channel 128 can include a curvature between the first position 108 and the second position 110.

With particular reference to FIG. 12, the brew chamber 102 can include two protrusions 146 disposed within respective channels 128 of two guide members 126 to move the brew chamber 102 along the pathway between the first position 108 and the second position 110. The protrusions 146 can be disposed along the exterior of the brew chamber 102. As an example, the protrusions 146 can be disposed near a top portion of the brew chamber 102 and offset from the center of the top of the brew chamber 102, as shown in FIG. 2. Each of the terminal ends of the channel 128 can act as a stopping point for the brew chamber 102 as it travels along the pathway of the channel 128. The size, shape, and length of the channel 128 can be adjusted depending on the desired angle (a) of the second position 110 relative to the first position 108. A skilled artisan can select a suitable size, shape, and length of cutout in the guide member 126 that can form the channel 128 within the scope of the present disclosure.

It should be appreciated that the guide member 126 can include a top portion 127. The top portion 127 can be used where the brew chamber 102 is in the third position 111 to aid in compressing the coffee grounds 103.

With reference to FIG. 12, the coffee machine 100 can further include an arm 130 disposed adjacent to the brew chamber 102. When the piston is at the second point 120, the arm 130 can be configured to sweep the coffee grounds 103 off of the piston 104 as the brew chamber 102 moves from the second position 110 to the first position 108 and into a waste area 142. The arm 130 can include a scraping edge in slidable contact with the brew chamber 102 as it moves from the second position 110 to the first position 108 with the piston 104 at the second point 120. The arm 130 can include a rubberized edge in contact with the brew chamber 102 and piston 104, as an example. As a further non-limiting example, the arm 130 can be spring-loaded or stationary, as shown in FIG. 12. Advantageously, the piston 104 and arm 130 can work together to allow the machine 100 to self-clean. In this way, it is not necessary for the user to empty the machine 100 after each use and the user does not have to remove wet coffee grounds 103 from the brew chamber 102. The user could wait until several cups of coffee are brewed before emptying the waste area 142. Desirably, the user would never have to touch wet coffee grounds 103.

With continued reference to FIG. 12, the arm 130 can have a length (not shown) that is substantially the same or greater than a diameter (not shown) of the brew chamber 102 to militate against any coffee grounds 103 remaining on the piston 104 after the arm 130 has passed over it. The length of the arm 130 can be selected by a skilled artisan to correspond with dimensions of the brew chamber 102 and piston 104, as desired.

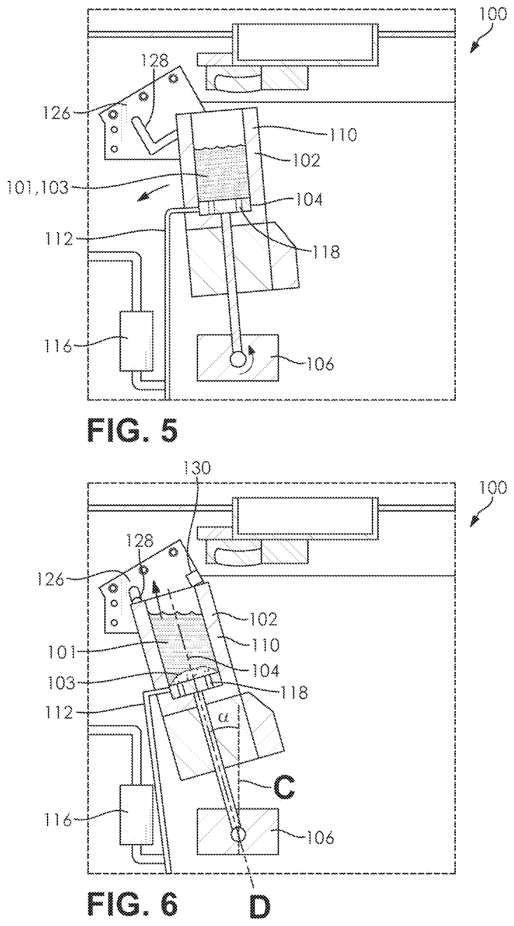

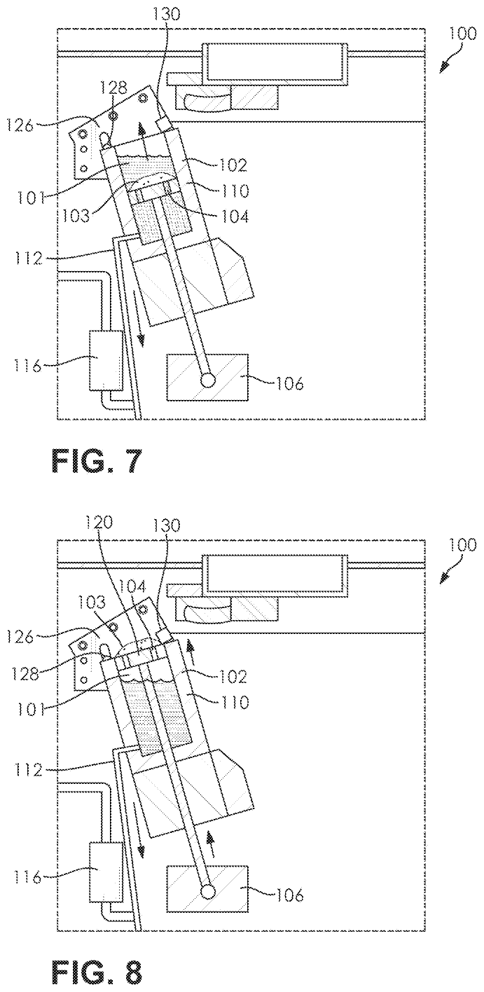

FIGS. 4-11 depict the stepwise process of using the brew chamber 102 to brew coffee 101 from coffee ground 103. In FIG. 4, the brew chamber is in the first position 102 along Axis C. As further shown, coffee grounds 103 and water can be added to the brew chamber 102. The brew chamber 102 can move from the first position 108 to the second position 110 along the guide member 126, as shown in FIG. 5. The brew chamber 102 can rest in the second position 110 along Axis D for a predetermined amount of time as determined by the user, as shown in FIG. 6. With reference to FIG. 7, while the brew chamber 102 is in the second position 110, the piston 104 can move from the first point 118 to the second point 120 along Axis D. As shown in FIG. 7, as the piston 104 moves from the first point 118 to the second point 120, the brewed coffee 101 can flow through the piston 104 via the filter portion 124 and the coffee grounds 103 can begin to collect atop the piston 104. Where the piston 104 is at the second point 120, shown in FIG. 8, the coffee grounds 103 can collect on the top of the piston 104. With reference to FIG. 9, the brew chamber 102 can move from the second position 110 to the third position 111. In the third position 111, the coffee grounds 103 can be compressed. As shown in FIG. 10, the brew chamber 102 can move from the third position 111 to the first position 108 through the intermediary second position 110. As the brew chamber 102 moves from the third position 111 to the first position 108, the arm 130 can sweep the compressed coffee grounds 103 from the piston 104, shown in FIG. 12. The brew chamber 102 can return to the first position 108 and the piston 104 can move from the second point 120 to the first point 118, as shown in FIG. 12.

In certain embodiments, the coffee machine 100 can include a seal member (not shown) configured to seal off the brew chamber 102 once liquid has entered the brew chamber 102. Where the brew chamber 102 is sealed, the seal member can be disposed adjacent to the brew chamber 102 and be configured substantially as the same size as an opening of the brew chamber 102. A skilled artisan can select a suitable size and material for the seal member within the scope of the present disclosure.

As shown in FIGS. 2 and 13, the coffee machine 100 can include a bean hopper 132 and a grinder 134. With reference to FIG. 2, the bean hopper 132 can be disposed at or near the top of the machine 100. Embodiments include where the bean hopper 132 can be configured to hold about 340 grams of whole coffee beans and can move the beans into the grinder 134. The grinder 134 can be configured to mill coffee beans into coffee grounds 103 and can be operated by the motor 106. As a non-limiting example, the grinder 134 can grind at a rate of 1.3 grams per second. A skilled artisan can select a suitable grind rate within the scope of the present disclosure. It should be appreciated that, in operation, the grinder 134 can draw beans from the bean hopper 132 and grind the beans into coffee grounds 103 such that the grounds fall into the brew chamber 102. A skilled artisan can select a suitable grinder within the scope of the present disclosure.

With continued reference to FIGS. 2 and 13, the coffee machine 100 can include a water reservoir 136. The water reservoir 136 can be configured to receive cold tap water and can store the water until the water is needed in the brew chamber 102 to brew the coffee. As a non-limiting example, the water reservoir 136 can hold between about 40 oz and about 80 oz, roughly enough water to make 4-8 cups of coffee. One of ordinary skill can select a suitable size for the water reservoir 136 such that it can be contained within the coffee machine 100 but still hold a large volume of water to militate against constant refilling within the scope of the present disclosure.

As shown in FIGS. 2 and 13, a water pump 138 can move the water from the water reservoir 136 to the brew chamber 102. The water pump 138 can pump water from the water reservoir 136 to the brew chamber 102 at a rate of about 0.23 fluid ounces per second. As a non-limiting example, the water pump 138 can include a 12 Volt DC Mini Pump, specifically model KPM27W-12B by Koge Electronics. A skilled artisan can select a suitable water pump 138 within the scope of the present disclosure.

As shown in FIG. 13, the coffee machine 100 can include a heating element 140. As the water is pumped from the water reservoir 136 via the water pump 138, the water can pass through the heating element 140. As a non-limiting example, the heating element 140 can be electric or any other type of conventional heating element. More particularly, the heating element 140 can be a boiler. One of ordinary skill can select other suitable heating elements within the scope of the present disclosure. In certain embodiments, the coffee machine 100 can include a manually settable thermostat that can allow the heating element 140 to maintain the temperature of the water at a predetermined temperature. The heating element 140 can raise the temperature of the water such that the water is acceptable for brewing coffee. As a non-limiting example, the heating element 140 can raise the temperature of the water to a temperature of about 150° F. to about 212° F. More specifically, the heating element can raise the temperature of the water to a temperature of about 175° F. to about 200° F. One of ordinary skill can select other suitable temperatures for brewing within the scope of the present disclosure.

The coffee machine 100 can include a water filter (not shown) disposed at a fill point of the water reservoir 136 or at a position between the water reservoir 136 and the brew chamber 102. The water filter can filter the water that is used to brew the coffee. The user can omit the water filter from the coffee machine 100, particularly where the coffee machine 100 is installed in an establishment that has a water-purification system separate from the machine 100.

The coffee machine 100 can also include a waste area 142, shown in FIG. 2. The waste area 142 can be configured to receive used coffee grounds 103. The waste area 142 can be configured to be removed from the coffee machine 100 for emptying or can include a chute that empties directly into a waste receptacle. One of ordinary skill can select a suitable means for disposing of the used grounds within the scope of the present disclosure. The waste area 142 can be configured to receive run off liquids and debris from the coffee machine 100. A skilled artisan can select a suitable location within the coffee machine 100 for the waste area 142 such that the waste, specifically coffee grounds and run off liquid, do not need to be moved far to enter the waste area 142.

As described hereinabove, the coffee machine 100 can have programmable features such as an auto start time, a selectable brewing time, a selectable brew volume, and a selectable coffee strength. As non-limiting examples, the selectable brew time can range from about 1 minute to about 10 minutes. The selectable brewing volume can range from about 8 oz to about 14 oz. The selectable coffee strength can be a ratio of coffee to water of about 1:12.

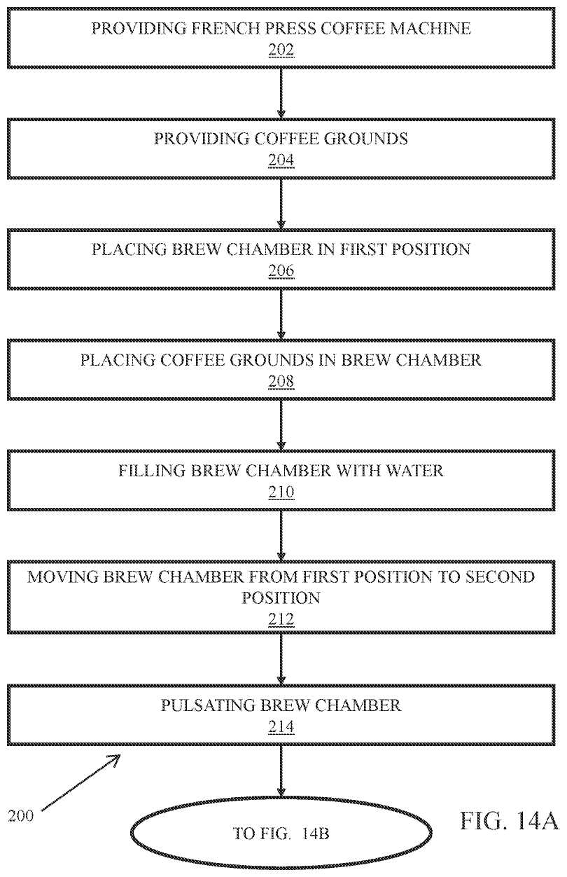

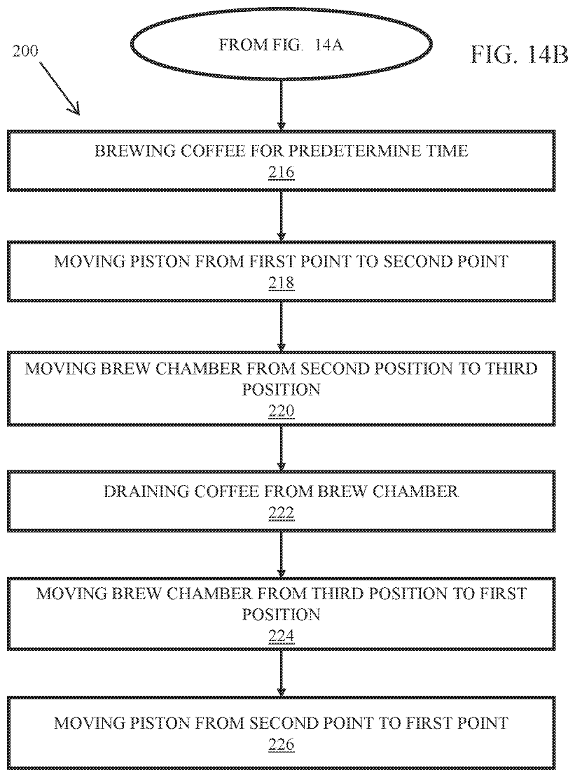

The present disclosure further provides a method for brewing coffee from coffee grounds 103, shown in the flowchart of FIGS. 14A and 14B. In a step 202, a French press coffee machine 100, as described herein, can be provided. The coffee grounds 103 can be provided in a step 204. In a step 206, the brew chamber 102 can be placed in the first position 108. The coffee grounds 103 can be placed into the brew chamber 102 in a step 208. In a step 210, the brew chamber 102 can be filled with a predetermined amount of water. The brew chamber can move from the first position 108 to the second position 110 in a step 212. In a step 214, the motor 106 can pulsate the brew chamber 102 to saturate the coffee grounds 103 with water. The coffee can brew for a predetermined amount of time in a step 216. As a non-limiting example, the predetermined amount of time for brewing can be between about 3.5 minutes and 5 minutes. More particularly, the predetermined amount of time for brewing can be about 4 minutes.

In a step 218, the piston 104 can move from the first point 118 to the second point 120 whereby the coffee grounds 103 are separated from the brewed coffee 101. The brew chamber 102 can be moved from the second position 110 to the third position 111, whereby the coffee grounds are compressed in a step 220. The brewed coffee 101 can be drained from the brew chamber 102 via the exit port 112 in a step 222. In a step 224, the brew chamber 102 can move from the third position 111 to the first position 108, whereby the arm 130 disposed adjacent to the brew chamber 102 can simultaneously sweep the coffee grounds 103 off of the piston 104 when at the second point 120. The brew chamber 102 can move from the third position 111 through the second position 110 in returning to the first position 108. In a step 226, the piston 104 can move from the second point 120 to the first point 118. The method 200 can be repeated as desired to brew additional coffee.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A French press coffee machine for brewing coffee from coffee grounds, comprising:
a brew chamber selectively moveable between a first position, a second position, and a third position, the brew chamber in the first position configured to receive coffee grounds, the brew chamber in the second position configured to brew coffee, the brew chamber in the third position configured to compress the coffee grounds;
a piston disposed within the brew chamber and selectively moveable between a first point and a second point to separate the coffee grounds from the brewed coffee; and
a motor disposed configured to selectively move the brew chamber between the first position, the second position, and the third position and configured to selectively move the piston between the first point and the second point.

2. The French press coffee machine of claim 1, further including a guide member configured to guide movement of the brew chamber between the first position, the second position, and the third position.

3. The French press coffee machine of claim 2, wherein the brew chamber is slidably disposed relative to a channel of the guide member.

4. The French press coffee machine of claim 1, wherein the brew chamber is vertical in the first position.

5. The French press coffee machine of claim 4, wherein the brew chamber in the second position is tilted between about 10° and about 50° relative to the first position.

6. The French press coffee machine of claim 4, wherein the brew chamber in the second position is tilted between about 20° and about 40° relative to the first position.

7. The French press coffee machine of claim 4, wherein the brew chamber in the second position is tilted to about 30° relative to the first position.

8. The French press coffee machine of claim 5, wherein the brew chamber moves longitudinally along an axis from the second position to the third position.

9. The French press coffee machine of claim 1, further including an arm disposed adjacent to the brew chamber.

10. The French press coffee machine of claim 9, wherein the arm is configured to sweep the coffee grounds off the piston as the brew chamber moves from the second position to the first position and the piston is at the second point.

11. The French press coffee machine of claim 1, wherein the brew chamber includes an exit port.

12. The French press coffee machine of claim 11, further including a pump configured to move brewed coffee from the brew chamber through the exit port.

13. The French press coffee machine of claim 1, wherein the motor is configured to selectively pulsate the brew chamber to saturate coffee grounds with water contained therein.

14. The French press coffee machine of claim 1, wherein the brew chamber has an interior circumference substantially equal to an exterior circumference of piston.

15. The French press coffee machine of claim 1, wherein the piston includes a filter configured to allow brewed coffee to pass through the piston as the piston moves between the first point and the second point.

16. A method for brewing coffee from coffee grounds, comprising:
providing a French press coffee machine having a brew chamber selectively moveable between a first position, a second position, and a third position, the brew chamber in the first position configured to receive coffee grounds, the brew chamber in the second position configured to brew coffee, the brew chamber in the third position configured to compress the coffee grounds, a piston disposed within the brew chamber and selectively moveable between a first point and a second point to separate the coffee grounds from the brewed coffee, and a motor disposed adjacent to the brew chamber and configured to selectively move the brew chamber between the first position and the second position and configured to selected move the piston between the first point and the second point;
disposing the coffee grounds in the brew chamber in the first position;
disposing water in the brew chamber;
moving the brew chamber into the second position;
brewing the coffee for a predetermined time;
moving the piston from the first point to the second point, whereby the coffee grounds are separated from the brewed coffee;
moving the brew chamber from the second position to the third position, whereby the coffee grounds are compressed; and
removing the brewed coffee from the brew chamber.

17. The method of claim 16, wherein the French press coffee machine further includes an arm disposed adjacent to the brew chamber, the arm configured to sweep coffee grounds off of the piston as the brew chamber moves from the second position to the first position, the method further including a step of moving the brew chamber from the second position to the first position and sweeping the coffee grounds from the piston using the arm when the piston is at the second point.

18. The method of claim 16, further including a step of pulsating the brew chamber using the motor to saturate the coffee grounds with water.

19. The method of claim 16, wherein the predetermined time for brewing is between about 3.5 minutes to about 5 minutes.

20. The method of claim 16, wherein the predetermined time for brewing is about 4 minutes.
